(19) United States
(12) Patent Application Publication
(10) Pub. No.: US 2014/0262656 A1
(43) Pub. Date: Sep. 18, 2014

(54) POUNDING TUNE MASS DAMPER SYSTEMS AND CONTROLS

(71) Applicant: UNIVERSITY OF HOUSTON, Houston, TX (US)

(72) Inventors: Gangbing Song, Pearland, TX (US); Devendra Patil, Houston, TX (US); John Vartos, Houston, TX (US)

(73) Assignee: UNIVERSITY OF HOUSTON, Houston, TX (US)

(21) Appl. No.: 13/843,374

(22) Filed: Mar. 15, 2013

(51) Int. Cl. F16F 7/10

(52) U.S. Cl. CPC F16F 7/10
USPC 188/378

(57) ABSTRACT

A vibration dampener, including, a first beam comprising a first mounting end portion and a first peripheral end portion, wherein the first peripheral end portion comprises a tunable mass, and the first beam is configured to vibrate in tune with a vibrational frequency of a structure supporting the first beam at the first mounting end portion, a second beam comprising a second mounting end portion and a second peripheral end portion, wherein the second peripheral end portion comprises a ring disposed about the first beam, and a viscoelastic material disposed between the first beam and the ring, wherein the viscoelastic material is configured to dampen vibrational energy as the first beam vibrates toward the ring until the viscoelastic material becomes compressed between the first beam and the ring during the course of the impact.

This application is related to U.S. patent application Ser. No. 12/917,456, entitled “POUNDING TUNE MASS DAMPER WITH VISCOELASTIC MATERIAL”, filed Nov. 1, 2010, which is herein incorporated by reference.

### BACKGROUND

This section is intended to introduce the reader to various aspects of art that may be related to various aspects of the present invention, which are described and/or claimed below. This discussion is believed to be helpful in providing the reader with background information to facilitate a better understanding of the various aspects of the present invention. Accordingly, it should be understood that these statements are to be read in this light, and not as admissions of prior art.

Oil and natural gas may have a significant effect on modern economies and societies. Indeed, devices and systems that depend on oil and natural gas are ubiquitous. For instance, oil and natural gas are used for fuel in a wide variety of vehicles, such as cars, airplanes, boats, and the like. Further, oil and natural gas are frequently used to heat homes during winter, to generate electricity, and to manufacture a variety of everyday products.

In order to meet the demand for such natural resources, companies often invest significant amounts of time and money in searching for and extracting oil, natural gas, and other subterranean resources from the earth. Particularly, once a desired resource is discovered below the surface of the earth, drilling and production systems are often employed to access and extract the resource. These systems may be located onshore or offshore depending on the location of a desired resource. Offshore systems generally include riser systems useful in attaching surface-based structures to the sea bottom. For example, in a subsea well, the drilling risers may extend from the seafloor up to a rig on the surface of the sea. Risers, including subsea risers, may be subjected to the flow of fluids across their surfaces (both internal and external). The flow of fluids may lead to vibration of the riser, such as vortex-induced vibration. Over time, the vibration can lead to damage and/or failure of the riser.

### BRIEF DESCRIPTION OF THE DRAWINGS

Various features, aspects, and advantages of the present invention will become better understood when the following detailed description is read with reference to the accompanying figures in which like characters represent like parts throughout the figures, wherein:

FIG. 1 is a schematic diagram of an embodiment of a sub-sea resource extraction system having a riser system that utilizes a viscoelastic tuned mass damper system;

FIG. 2 is a cross-sectional view of a riser pipe taken along line 2-2 of FIG. 1, illustrating vortices that induces vibration;

FIG. 3 is an exemplary chart of energy magnitude versus frequency of a portion of riser pipe or cable of FIG. 1 without a viscoelastic tuned mass damper system;

FIG. 4 is a perspective view of an embodiment of a viscoelastic tuned mass damper system;

FIG. 5 is a cross-sectional side view of an embodiment of the viscoelastic tuned mass damper system of FIG. 4;

FIG. 6 is a cross-sectional side view of an embodiment of a viscoelastic tuned mass damper system;

FIG. 7 is a cross-sectional side view of an embodiment of a viscoelastic tuned mass damper system of FIG. 6;

FIG. 8 is a cross-sectional front view of an embodiment of a viscoelastic tuned mass damper system illustrating possible movement of an L-shaped beam;

FIG. 9 is a cross-sectional front view of an embodiment of a viscoelastic tuned mass damper system illustrating movement of an L-shaped beam;

FIG. 10 is a cross-sectional front view of an embodiment of a viscoelastic tuned mass damper system illustrating movement of an L-shaped beam;

FIG. 11 is a cross-sectional view of an embodiment of a viscoelastic material that has multiple layers;

FIG. 12 is a perspective view of a housing suitable for encapsulating a viscoelastic tuned mass damper system;

FIG. 13 is a view of a controller coupled to a variable frequency tuned mass damper system; and

FIG. 14 is a block diagram of an embodiment of the viscoelastic tuned mass damper system coupled to a platform and a plurality of risers.

### DETAILED DESCRIPTION OF SPECIFIC EMBODIMENTS

One or more specific embodiments of the present invention will be described below. These described embodiments are only exemplary of the present invention. Additionally, in an effort to provide a concise description of these exemplary embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skills having the benefit of this disclosure.

Certain exemplary embodiments of the present invention include systems and methods for dampening the vibration of risers, and other equipment used in sub-sea resource extraction systems. In particular, the disclosed embodiments include the use of viscoelastic material in combination with a tuned mass damper. More specifically, in certain embodiments, the tuned mass tamper may include a first beam (e.g., L-shaped or angled beam) having a tunable mass, wherein the first beam is coupled to and vibrates with certain riser structures. The tuned mass damper may also include a secure beam having a limiting device (e.g., a ring portion) disposed around a segment of the first beam. Furthermore, a viscoelastic material may be disposed on the segment of the first beam and/or the limiting device of the second beam. As the riser structure vibrates, the first beam with the tunable mass vibrates within the limiting device. As the first and second beams contact one another in the form of impact, the viscoelastic material absorbs the vibrational energy, thereby dampening the vibration in the riser system.

The techniques described herein may also include the use of certain devices and coatings suitable for long-term disposition of a pounding tune mass damper (PTMD) in an undersea environment. For example, filter housings and/or biological growth inhibitors may be used to minimize or eliminate marine growth and other fouling agents. The PTMD may be used in a variety of orientations, including vertical orientations, angled orientations, and horizontal orientations. Further, the PTMD may include passive and/or active tuning techniques, suitable for tuning the PTMD to a variety of riser structures and environmental conditions. It is to be noted that while the embodiments disclosed herein are described in terms of a subsea environment, similar embodiments may be used in above ground surfaces, such as guide wires or cables, bridge support cables, and the like.

With the foregoing in mind and turning now to FIG. 1, the figure is a diagram that illustrates an embodiment of a subsea resource extraction system 10. The illustrated resource extraction system 10 can be configured to extract various minerals and natural resources, including hydrocarbons (e.g., oil and/or natural gas), or configured to inject substances into the earth. In some embodiments, the resource extraction system 10 is land-based (e.g., a surface system) or subsea (e.g., a subsea system). As illustrated, the system 10 includes a wellhead assembly 12 coupled to a mineral deposit 14 via a well 16, wherein the well 16 includes a well-bore 18.

The wellhead assembly 12 typically includes multiple components that control and regulate activities and conditions associated with the well 16. For example, the wellhead assembly 12 generally includes bodies, valves and seals that route produced minerals (e.g., hydrocarbons) from the mineral deposit 14, provide for regulating pressure in the well 16, and provide for the injection of chemicals into the well-bore 18 (e.g., down-hole). In the illustrated embodiment, the wellhead assembly 12 may include a tubing spool, a casing spool, and a hanger (e.g., a tubing hanger and/or a casing hanger). The system 10 may include other devices that are coupled to the wellhead assembly 12, such as a blowout preventer (BOP) stack 20 and devices that are used to assemble and control various components of the wellhead assembly 12. For example, in certain embodiments, the BOP stack 20 may include a lower BOP stack 22 and a lower marine riser package (LMRP) 24, which may be coupled by a hydraulically operated connector, such as a riser connector. The BOP stack 20 may include a variety of valves, fittings and controls to block oil, gas, or other fluid from exiting the well in the event of an unintentional release of pressure or an overpressure condition.

A drilling riser 26 including one or more riser joints 27 may extend from the BOP stack 20 to a rig 28, such as a platform or floating vessel. For example, the rig 28 may be positioned above the well 16. The rig 28 may include components suitable for operation of the mineral extraction system 10, such as pumps, tanks, power equipment, and any other components. In the illustrated embodiment, the rig 24 includes a derrick 30 to support the drilling riser 26 during running and retrieval, a tension control mechanism, and other components.

The drilling riser 26 may carry drilling fluid (e.g., “mud) from the rig 28 to the well 16, and may carry the drilling fluid (“returns”), cuttings, or any other substance, from the well 16 to the rig 28. The drilling riser 26 may include a main line having a large diameter and one or more auxiliary lines. The main line may be connected centrally over the bore (such as coaxially) of the well 16, and may provide a passage from the rig 28 to the well 16. The auxiliary lines may include choke lines, kill lines, hydraulic lines, glycol injection, mud return, and/or mud boost lines. For example, some of the auxiliary lines may be coupled to the BOP stack 20 to provide choke and kill functions to the BOP stack 20.

The drilling riser 26 may also include additional components, such as flotation devices, clamps, or other devices distributed along the length of the drilling riser 26. For example, the illustrated drilling riser 26 includes buoyancy cans 31 coupled to an exterior of the drilling riser 26. Specifically, the buoyancy cans 31 are containers, which may be cylindrical, that form an annulus about the exterior of the drilling riser 26 and include chambers, which may be filled with air, low density fluid, or other material. As a result, the buoyancy cans 31 may operate to apply tension (e.g., an upward force) to the drilling riser 26. In this manner, a desired tension in the drilling riser 26 may be maintained. Furthermore, in certain embodiments, the buoyancy cans 31 may be variable or fixed. In other words, certain buoyancy cans 31 (e.g., variable buoyancy cans) may allow injection or removal of air or other fluid in the buoyancy cans 31, thereby adjusting the tension (e.g., upward force) that the buoyancy cans 31 apply to the drilling riser 26. Other buoyancy cans 31 (e.g., fixed buoyancy cans) may not allow for the adjustment of tension (e.g., upward force) applied by the buoyancy cans 31 to the drilling riser 26.

As described further below, the drilling riser 26 may be formed from numerous “joints” of pipe (e.g., riser joints 27), coupled together via flanges, joints, or any other suitable devices or connectors. In the illustrated embodiment, the drilling riser 26 includes multiple joints 32 which couple the drilling riser 26 to various components of the subsea mineral extraction system 10. For example, a flexible joint 34 (e.g., a first flexible joint 36) couples the drilling riser 26 to the rig 28. Additionally, another flexible joint 34 (e.g., a second flexible joint 38) couples the drilling riser 26 to the BOP stack 20. As will be appreciated, the flex joints 34 may be configured to reduce bending stresses in the drilling riser 26. For example, each flex joint 34 may include a ball and socket assembly having a central passage extending through the flex joint 34, through which the drilling fluid and other working fluids may pass.

Furthermore, the drilling riser 26 may include a tensioner or telescopic joint 40. The tensioner 40 is a riser joint that includes inner and outer tubes or barrels, which may move relative to one another. Specifically, the barrels of the telescopic joint 40 may move relative to one another to allow for changes in the length of the drilling riser 26 as the rig 28 moves due to winds, ocean currents, and so forth. Additionally, the telescopic joint 40 may also include a central passage extending through the telescopic joint 40, through which the drilling fluid and other working fluids may pass.

One or more vibration damper systems (e.g. PTMDs) 39 may be disposed at various locations of the resource extraction system 10 and used to minimize vibration, for example, vortex-induced vibration. Vortex-induced vibration is generally caused by currents (e.g., water currents) flowing across structures such as riser pipe and cables. In the illustrated example, currents may flow across the risers 27, anchor cabling 41, and/or anchor cabling 43 attaching, for example, vessel 45 to a seabed. Such currents may lead to vibration. However, as further described herein, the vibration damper systems 39 may minimize or eliminate vibrations, including vortex-induced vibration. As depicted, the vibration damper systems 39 may be disposed at various angles and orientations. For example, any vibration damper system 39 may be disposed at an angle α between 0° to 360° with respect to a vertical axis 44 and/or a horizontal axis 46. Further, multiple vibration damper systems 39 may be disposed on a structure, such as the drilling riser 26, the anchor cabling 41, and/or the anchor cabling 43. Additionally, each vibration damper system 39 may be tuned to a desired frequency, such as a natural frequency and related frequencies (e.g., normal mode frequencies) of a desired riser. By disposing multiple vibration damper systems 39, including vibration damper systems 39 tuned to minimize vibrations at a given frequency, an improved reduction of vibration may be enabled, thus extending the life of certain structures.

Turning to FIG. 2, the figure is a cross-sectional view of the riser tube 27 taken along line 2-2 of FIG. 1. As the current flows across riser tube 27, the current flow is slowed by contact with the surface of the riser tube 27. Vortices 48, 50 may be formed on a back side 52 of the riser tube 27, away from the direction of flow of the current. However, these vortices 48, 50 are generally not synchronous. Rather, for example, a top vortex 48 may first be formed, followed by a bottom vortex 50, followed by another top vortex 48, and so forth. This pattern of successive vortices 48, 50 may cause oscillating forces on top and bottom surfaces 54, 56 of the riser tube 27. As such, the oscillating forces may cause vertical vibration of the riser tube 27, as illustrated by arrow 58. There may also be vibrations in the direction of current. It is to be noted that the tuned damper embodiments disclosed herein may be used in any type of riser or cable, including flexible risers, steel cables, wound cables, chains, top tensioned risers (TTRs), steel catenary risers (SCRs), free standing risers (FSRs), steel lazy wave risers (SLWRs) and so on, described in more detail with respect to FIG. 14.

This vortex-induced vibration and other similar vibrations may lead to increased fatigue of the structures 26, 41, and/or 43 of the resource extraction system 10 over time. In general, the energy magnitude of a given section or portion of the structures 26, 41, and/or 43 may be a function of the frequency of the vortex-induced vibration. FIG. 3 is an example chart 60 of energy magnitude versus frequency for a portion of one of the structures 26, 41, and/or 43 of FIG. 1. The degree of damping is directly proportional to the energy magnitude. The energy magnitude illustrated in FIG. 3 is on a 20 log₁₀ decibel scale. For example, when the vortex-induced vibration is at a certain (very low) frequency, the energy magnitude may be at a reference level of 0 dB, meaning that the degree of damage is at a reference level of 100%. However, when the vortex-induced vibration is near the natural frequency ωₙ of the jumper system 18, as illustrated in FIG. 3, the energy magnitude may be at a level of 1000% or ten times (e.g., 20 dB) of the reference level. In other words, at lower frequencies, the energy magnitude may be at somewhat expected levels. However, when the vortex-induced vibration frequency is near the natural frequency ωₙ of the portion of one of the structures 26, 41, and/or 43, the energy magnitude is substantially greater. However, at even higher frequencies, the energy magnitude may asymptotically decrease to levels of approximately 3.163% (e.g., −30 dB) of the reference level. The illustrated energy magnitudes of FIG. 3 are merely exemplary and not intended to be limiting.

The natural frequency ωₙ of the portion of one of the structures 26, 41, and/or 43 is the frequency at which that portion vibrates with the largest energy magnitude when set in motion. In actuality, the portion may have multiple natural frequencies ωₙ (i.e. harmonic frequencies) above the natural frequency ωₙ illustrated in FIG. 3. However, for simplicity, only the fundamental natural frequency ωₙ is illustrated. In addition, the other natural frequencies ωₙ generally tend to have magnitudes that are less than the fundamental natural frequency ωₙ. Therefore, the fundamental first natural frequency ωₙ is generally the most important frequency to be considered when attempting to minimize the energy magnitude of the portion of one of the structures 26, 41, and/or 43. Indeed, as the frequency of the vortex-induced vibration approaches the fundamental natural frequency ωₙ illustrated in FIG. 3, the portion of one of the structures 26, 41, and/or 43 may become “locked-in.” In other words, the portion may become locked into a damage-inducing oscillating mode, which may be difficult to terminate. Therefore, the ability to minimize the maximum energy magnitude and/or change the fundamental natural frequency ωₙ may lead to lower overall damage to a system, thereby extending useful life of the structure. Any portion or section of the structures 26, 41, and/or 43 may be modeled or empirically studied to determine a natural frequency ωₙ. For example, the drilling riser 26 may be divided into 2, 3, 4, 5, 6, 7, 8, 9, 10, 100, 1000, 10000, or more sections, and each section modeled or empirically studied to determine its natural frequency ωₙ. Further, second, third, fourth, and more frequencies (e.g., normal mode frequencies) may be also determined. A vibration damper system 39 may then be tuned to better respond to vibrations at the frequency ωₙ or to respond to related frequencies.

FIG. 4 is a perspective view of an embodiment of the vibration damper system 39 coupled to a cable or to a pipe structure 80. The vibration damper system 39 assists in changing the natural frequency of pipe(s) and/or reduces the vibrational energy caused by exposure to wind or water turbulence. The vibration damper system 39 includes a mass 72, a first beam 74, a second beam 76, and viscoelastic material 78. In the illustrated embodiment, the first beam 74 is an L-shaped beam having a first beam portion 82 and a second beam portion 84, wherein the first and second beam portions 82 and 84 are generally crosswise (e.g., perpendicular) to one another. The first beam portion 82 extends crosswise (e.g., perpendicular) to the pipe structure 80, while the second beam portion 84 extends along (e.g., parallel to) the pipe structure 80. The second beam 76 includes a first portion 92 and a second portion 94. The first portion 92 is crosswise (e.g., perpendicular) to the pipe structure 80, and is generally an elongated beam structure. The second portion 94 is a limiting device (e.g., a ring) that surrounds and provides a limited range of motion of the first beam 74 therein. Thus, the viscoelastic material 78 may be a ring-shaped strip inside the second portion 94. As discussed in detail below, the first and second beams 74 and 76 cooperate with one another to dampen vibration in the pipe structure 80.

In the present embodiment, the vibrational damper system 39 dampens vibrations in the pipe structure 80 (e.g., a portion of the structures 27, 41, or 43) as the first beam 74 vibrates and impacts the viscoelastic material 78 within the second beam 76. The pipe structure 80, as explained above, may be subjected to turbulence by either wind or water that causes the pipe 78 to vibrate. As the pipe 80 vibrates, it causes the first beam 74 and mass 72 to vibrate. In some embodiments, the mass 72 is tuned to enable the first beam 74 to vibrate at the same natural frequency as the pipe structure 80. Thus, as the pipe structure 80 begins to vibrate at a specific frequency, the first beam 74 with the tuned mass 72 will correspondingly vibrate at the same frequency. At specific frequencies (e.g., resonance frequencies), the oscillations of the pipe structure 80 will cause the mass 72 and the first beam 74 to reach amplitudes sufficient for the first beam 74 to impact the second beam 76. The impact of the first beam 74 against the second beam 76 compresses the viscoelastic material 78 between the first beam 74 and the second beam 76. This impact allows the viscoelastic material 78 to absorb vibrational energy and thus dampen the vibrations of the pipe structure 80. In some embodiments, the second beam 76 may have a significant stiffness to reduce the introduction of additional dynamics, to the pipe structure 80, caused by the impact of the first beam 74 against the second beam 76. In this manner, the vibration damper system 39 limits/reduces the vibrational energy in the pipe structure 80.

Viscoelastic material is defined as material that exhibits the property of viscoelasticity. Viscoelastic materials have both viscous and elastic characteristics. Viscous materials resist shear flow and strain linearly with time when a stress is applied. Elastic materials strain instantaneously when stretched and then return to their original state once the stress is removed. Viscoelastic materials exhibit elements of both of these properties, and as such, exhibit time dependent strain. Exemplary viscoelastic materials may include acrylic viscoelastic material, viscoelastic damping polymer. These viscoelastic materials may come in a variety of forms (e.g., tape, spray coating, brush coating, premolded, a solution for dipping, etc.) These different forms facilitate the attachment and placement of the viscoelastic material 78 on the vibration damper system 39. The system 39 may be attached to risers, cables, chains, and so on, using a variety of techniques. For example, the components 82 and 92 may be welded to the structure 80, adhered (e.g., using glues, thermal bonding, and so on), clamped (e.g., hose clamped, screw/band clamped, wire clamped, ear clamped, spring clamped), bolted, screwed in place, or a combination thereof.

FIG. 5 is a cross-sectional side view according to an embodiment of the damper system 39 of FIG. 4. As illustrated in FIG. 5, the first beam 74 is an L-shaped having the first beam portion 82 and the second beam portion 84 crosswise to one another. In other embodiments, the first beam 74 may curve or arc from the pipe structure 80 to the mass 72. The first beam portion 82 further defines an end portion 86 connected to the pipe structure 80 via a connection 88, such as a weld, a flange, a bolt, or any combination thereof. The connection 88 of the first beam 74 to the pipe structure 80 allows vibrational energy to transfer from the pipe structure 80 to the first beam 74 and the mass 72. The second beam portion 84 likewise defines a peripheral end portion 90, which couples to the mass 72 with a connection 89 such as a weld, a flange, a bolt, or an integral casting or machining with the second beam portion 84. The illustrated mass 72 is a solid cylinder, although embodiments of the mass 72 may include a square, spherical, oval, triangular, or other shape. Furthermore, the mass 72 may not be a single unitary mass, but may include several pieces that are distributed along the first beam 84 rather than connected solely at the end 90. In other embodiments, the second beam portion 84 may provide sufficient mass without the mass 72.

In order to limit/reduce vibration in the pipe structure 80, the vibration damping system 39 includes the second beam 76 to limit movement of the first beam 74 and dampen vibration with the viscoelastic material 78. The second beam 76 includes the first portion 92 and the second peripheral end portion 94. The first portion 92 defines an end portion 96 that is coupled to the pipe structure 80 with a connection 98, such as a weld, a flange, a bolt, or a combination thereof. In other embodiments, the second beam 76 may be attached to another structure rather than the pipe structure 80. For instance, only the L-shaped beam 74 may be attached to the pipe structure 80, while the second beam 76 attaches to another structure.

The second portion 94 of the second beam 76 is ring shaped and defines a circular opening 100. In other embodiments, the second portion 94 may define a different shaped opening 100, such as an oval opening, a square opening, a polygonal opening, a rectangular opening, a triangular opening, or any other shape. Alternatively the second portion 94 may define a non-continuous opening 100, e.g., one or more limiting structures above, below, left, and/or right of the first beam 74. The opening 100 surrounds a segment 102 of the first beam 74, and defines a limited range of movement of the segment 102 within the opening 100. For example, the opening 100 defines upper and lower ranges of movement 101 and 103 and left and right ranges of movement (i.e., in and out of the page). As mentioned above, as the pipe structure 80 vibrates in response to wind, water flow, or other drivers, the mass 72 and first beam 74 may corresponding begin to vibrate. Once the first beam 74 reaches a specific amplitude, the segment 102 contacts the viscoelastic material 78 disposed around the opening 100. The viscoelastic material 78 is therefore able to absorb vibrational energy from the pipe structure 80 by contact with the segment 102 of the first beam 74. As discussed above, the second beam 76 may have a significant stiffness and therefore may not emit a large vibrational response from the impact of the first beam 74 within the ring portion 94. In this way, the stiffness of the second beam 76 aids the viscoelastic material 78 in damping vibration in the pipe structure 80.

FIG. 6 is a cross-sectional side view of an embodiment of a viscoelastic tuned mass damper system 39. In the embodiment of FIG. 6, the viscoelastic material 86 wraps around the L-shaped pipe 74, rather than lining the opening 100 in the second portion 94 (e.g., ring portion) of the second beam 76. This may reduce the amount of viscoelastic material 78 to dampen vibration between the first beam 74 and the second beam 76. In certain embodiments, the viscoelastic material 78 may include viscoelastic tape, a viscoelastic sleeve, a viscoelastic coating, or a combination thereof, disposed on the segment 102 of the first beam 74.

FIG. 7 is a cross-sectional side view of a viscoelastic tuned mass damper system 39 according to another embodiment. In the embodiment of FIG. 7, the viscoelastic material 78 is placed on both the first beam 74 and the opening 100 of the second beam 76 (e.g., ring portion). Thus, during vibration, viscoelastic material 78 will contact viscoelastic material 78 as the first beam 74 moves toward and away from the second beam 76, thereby improving the dampening of vibrational energy. Furthermore, the illustrated embodiment provides redundancy with the viscoelastic material 78 in both locations, thereby ensuring that at least one viscoelastic material 78 is available for dampening vibrational energy. For instance, if the viscoelastic material 78 detaches from the opening 100, then the viscoelastic material 78 on the first beam 74 is still able to dampen vibrational energy, and vice versa.

FIG. 8 is a cross-sectional front view of a damper system 39 illustrating possible movement of the second beam portion 84 of the first beam 74 within the second portion 94 (e.g., ring portion) of the second beam 76. For instance, if the vibration in the pipe structure 80 is in the vertical direction, then the tuned mass 72 and the first beam 74 will move in the direction of arrows 110, as illustrated in FIGS. 8 and 9. Likewise, if the vibration is in a horizontal direction, then the tuned mass 72 and the first beam 74 will move in the direction of arrows 112, as illustrated in FIGS. 8 and 10. Although, FIGS. 8-10 illustrate movement of the first beam 74 only in vertical or horizontal directions, the second beam 76 (e.g., ring portion) will allow movement in any lateral direction relative to an axis of the first beam 74. This multi-directional (e.g., 360 degrees) range of movement of the first beam 74 within the second beam 76 (e.g., ring portion) enables vibrational dampening of vibrational energy in any direction as the pipe structure 80 vibrates.

As discussed above, the opening 100 of the second beam 76 may have a variety of shapes to control dampening in various directions. For instance, if more damping is desired in a specific direction due to the design of the pipe structure, then the opening 100 may define a different shape that reduces vibration in certain directions while allowing more in others. For example, the opening 100 could be oval or rectangular in shape. These shapes may allow greater oscillations in one direction while reducing them in another. In still other embodiments, the viscoelastic material 78 thickness may be increased in designated locations of the opening 100 or on the first beam 74. The increased thickness may reduce vibrations in certain directions or compensate for viscoelastic material 78 wear by more frequent impact in known locations.

FIG. 11 is a cross-sectional view of an embodiment of the viscoelastic material 78 with multiple layers. For instance, the viscoelastic material 78 may include multiple layers (e.g. 2 to 10 or more layers). In the illustrated embodiment, the viscoelastic material 78 includes six layers 120, 122, 124, 126, 128, and 130. Each of these layers may include the same viscoelastic material or a different viscoelastic material than the other layers. In still other embodiments, different layers may have a first viscoelastic material while other layers may have a second viscoelastic material or a non-viscoelastic material. For example, layer 120 may be different from layers 122, 124, 126, 128, and 130. The layers may also differ in their properties relative to the other layers (e.g., each layer may be 5-100 percent different in its viscoelastic property, dampening value, etc., with respect to another layer). Furthermore, the layers may vary in thickness (e.g., 1 to 5, 1 to 10, 1 to 100, or 1 to 1000 percent different) in comparison to the other layers. The combination of the different layers may improve damping of the pipe structure 80 and/or protection of the viscoelastic material from environmental and/or impact damage.

FIG. 12 is a perspective view of an embodiment of the vibration damper system 39 coupled to a cable or to a pipe structure 80 and enclosed by a housing 140. As mentioned above, the vibration damper system 39 assists in changing the natural frequency of pipe(s) and/or reduces the vibrational energy caused by exposure to wind or water turbulence. The vibration damper system 39 includes the mass 72, the first beam 74 having the portion 82 and the portion 84, the second beam 76 having the portion 92 and the portion 94, and viscoelastic material 78. All of the depicted components, 72, 74, 76, 78, 82, 84, 92, 94 may be encapsulated by the housing 140.

In the depicted embodiment, the housing 140 is a square housing 140 including six walls 142, 144, 146, 148, 150, and 152. In one embodiment, the walls 142, 144, 146, 148, 150, and 152 are mesh walls that enable fluid (e.g., saltwater) to flow through but block detritus, debris, and biological organisms (e.g., barnacles) from growing and/or interfering with operations of the components 72, 74, 76, 78, 82, 84, 92, 94. In another embodiment, the walls 142, 144, 146, 148, 150, and 152 are solid walls and the components 72, 74, 76, 78, 82, 84, 92, 94 may be immersed in a biological growth-inhibitor fluid. The solid walls 142, 144, 146, 148, 150, and 152 may contain the biological growth-inhibitor fluid but block outside fluid (e.g., saltwater) from entering the housing 140. In another embodiment, the components 72, 74, 76, 78, 82, 84, 92, 94 may be coated with a gel or coating that inhibits biological growth. Accordingly, the components 72, 74, 76, 78, 82, 84, 92, 94 may be better protected against interference during operations caused by marine organisms and/or detritus.

FIG. 13 is a view of an embodiment of the vibration damper system 39 communicatively coupled to a controller 160 through conduits 162. In the depicted embodiment, a beam extender 164 may be used to control a length of the beam portion 84. The beam extender 164 may be a hydraulic cylinder (e.g., telescoping cylinder), a variable piston extender, a linear actuator, a screw actuator, and/or so on, suitable for changing the length of the beam portion 84. For example, the beam length may be changed between 0%-5%, 0%-10%, 0%-20%, 0%-30%, 0%-40%, 0%-50%, 0%-60%, 0%-70%, 0%-80%, 0%-90%, or more.

Also depicted is a vibration sensor 166 communicatively coupled to the controller 160 through a conduit 168. The controller 160 may receive signals from the sensor 166 representative of a vibration. The controller 160 may use the signals to derive, for example, the natural frequency ωₙ of the portion of the structure 27, 41, and/or 43 having the depicted cable or tube 80. The controller 160 may then extend or retract the beam 84 by using the beam extender, thus fine tuning the dampening of vibrational energy. For example, extending the beam 84 may increase the amplitude response of the member 74, and decreasing the length of the beam 84 may decrease the amplitude response of the member 74. Additionally or alternatively, the mass 72 may be replaced in situ, for example by using a human diver or remotely operated underwater vehicle, to accommodate a variety of conditions. In this manner, the vibration damper system 39 may be fine-tuned to respond to a variety of conditions.

FIG. 14 is a block diagram of an embodiment of a platform 170 utilizing various different types of risers. As mentioned above, various types of risers and tendons may be used and the techniques described herein, such as the vibration damper system 39, may be used to provide for dampening of vibrations. In the depicted embodiment, the platform 170 is depicted as having various risers and tendons, such as a steel lazy wave riser (SLWR) 172, a steel catenary riser (SCR) 174, several tendons 176, a top tensioned riser (TTR) 178 anchored to a seabed via anchor point 180, a free standing riser 182 also anchored via anchor point 180 and including a buoy 184. As illustrated, the vibration damper system 39 may be disposed at various locations of each of the risers 172, 174, 178, 182, and tendons 176. Accordingly, the risers 172, 174, 178, 182 and platform 170 may be more stable than when the system 39 is not used, thus increasing the useful life of the risers 172, 174, 178, 182, platform 170 and related components.

It is to be noted that, while the depicted embodiment shows the platform 170 tethered to the sea bottom by using a variety of risers 172, 174, 178, 182, and tendons 176, in other embodiments, the platform 170 may use a subset of the risers 172, 174, 178, 182, and/or tendons 176, depending, for example, on the type of the platform 170. For example, in embodiments where the platform 170 is a fixed platform or a compliant tower platform, then the risers 172, 174, 178, 182 may be used while the tendons 176 may not be used. Likewise, if the platform 170 is a sea star platform, a floating production system, a tension leg platform, or a spar platform, then the risers 172, 174, 178, 182 may be used along with the tendons 176.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

1. A system, comprising:
a riser; and
a vibration dampener coupled to the riser, comprising:
a first beam comprising a first mounting end portion and a first peripheral end portion, wherein the first peripheral end portion comprises a tunable mass, and the first beam is configured to vibrate in tune with a vibrational frequency of a structure supporting the first beam at the first mounting end portion;
a second beam comprising a second mounting end portion and a second peripheral end portion, wherein the second peripheral end portion comprises a ring disposed about the first beam; and
a viscoelastic material disposed between the first beam and the ring, wherein the viscoelastic material is configured to dampen vibrational energy as the first beam vibrates toward the ring until the viscoelastic material becomes compressed between the first beam and the ring.

2. The system of claim 1, wherein the viscoelastic material is disposed on the ring.

3. The system of claim 1, wherein the viscoelastic material is disposed on the first beam.

4. The system of claim 1, wherein the viscoelastic material comprises a first viscoelastic portion disposed on the first beam and a second viscoelastic portion disposed on the ring.

5. The system of claim 4, wherein the first and second viscoelastic portions have different material compositions, thicknesses, dampening values, or a combination thereof.

6. The system of claim 1, wherein the vibration dampener is coupled to the riser by bolts, welds, or a combination thereof.

7. The system of claim 1, wherein the viscoelastic material comprises a plurality of viscoelastic layers.

8. The system of claim 1, wherein the first beam comprises an L-shaped beam.

9. The system of claim 1, wherein the riser comprises a steel lazy wave riser, a steel catenary riser, a top tensioned riser, a free standing riser, or a combination thereof.

10. A system, comprising:
a vibration dampener, comprising:
an L-shaped beam coupled to a riser, wherein the L-shaped beam comprises a first segment protruding outwardly from the tubular and a second segment extending generally parallel to the tubular, and the second segment comprises a mass configured to tune the L-shaped beam to vibrate at a vibrational frequency of the tubular;
a ring coupled to the riser, wherein the second segment of the L-shaped beam extends through the ring;
a viscoelastic material disposed between the second segment and the ring, wherein the viscoelastic material is configured to dampen vibrational energy as the second segment vibrates toward the ring until the viscoelastic material becomes compressed between the second segment and the ring; and
a controller configured to control the vibration dampener.

11. The system of claim 10, wherein the controller is configured to increase or reduce a length of the first segment.

12. The system of claim 10, wherein the viscoelastic material is disposed on the ring, the second segment, or a combination thereof.

13. The system of claim 10, wherein the viscoelastic material comprises a first viscoelastic portion disposed on the second segment and a second viscoelastic portion disposed on the ring.

14. The system of claim 13, wherein the first and second viscoelastic portions have different material compositions, thicknesses, dampening values, or a combination thereof.

15. The system of claim 10, comprising a frequency sensor coupled to the tubular, wherein the controller is configured to control the vibration dampener based on signals received from the frequency sensor.

16. The system of claim 10, wherein the viscoelastic material comprises a plurality of viscoelastic layers having different material compositions, thicknesses, dampening values, or a combination thereof.

17. A system, comprising:
a vibration dampener coupled to a riser, comprising:
a beam coupled to the mineral extraction component, wherein the beam is configured to vibrate in tune with vibration of the mineral extraction component;
a ring separate from the beam, wherein the beam extends through the ring; and
a viscoelastic material disposed between the beam and the ring, wherein the viscoelastic material is configured to dampen vibrational energy as the beam vibrates toward the ring until the viscoelastic material becomes compressed between the beam and the ring.

18. The system of claim 17, wherein the riser comprises a steel lazy wave riser, a steel catenary riser, a top tensioned riser, a free standing riser, or a combination thereof.

19. The system of claim 17, wherein the viscoelastic material is a viscoelastic tape.

20. The system of claim 17, wherein the vibration dampener is coupled to the riser by a weld, an adhesive, a clamp, or a combination thereof.
